(19) United States
(12) Patent Application Publication
(10) Pub. No.: US 2023/0098682 A1
(43) Pub. Date: Mar. 30, 2023

(54) ASSISTANCE DATA FOR POSITION ESTIMATION USING CARRIER PHASE COMBINATION IN A CELLULAR POSITIONING SYSTEM

(71) Applicant: QUALCOMM Incorporated, San Diego, CA (US)

(72) Inventors: Jingchao BAO, San Diego, CA (US); Sony AKKARAKARAN, Poway, CA (US)

(21) Appl. No.: 17/449,568

(22) Filed: Sep. 30, 2021

(51) Int. Cl. H04W 64/00

(52) U.S. Cl. CPC H04W 64/00

(57) ABSTRACT

Various aspects of the present disclosure generally relate to wireless communication. In some aspects, an assisting node in a cellular positioning system may obtain one or more carrier phase measurements. The assisting node may transmit, and a positioning node in the cellular positioning system may receive, phase error related information associated with the one or more carrier phase measurements. Numerous other aspects are described.

### FIELD OF THE DISCLOSURE

Aspects of the present disclosure generally relate to wireless communication and to techniques and apparatuses associated with assistance data for position estimation using carrier phase combination in a cellular positioning system.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a positioning node in a cellular positioning system. The method may include receiving phase error related information associated with one or more carrier phase measurements obtained by one or more assisting nodes.

Some aspects described herein relate to a method of wireless communication performed by an assisting node in a cellular positioning system. The method may include obtaining one or more carrier phase measurements. The method may include transmitting, to a positioning node, phase error related information associated with the one or more carrier phase measurements.

Some aspects described herein relate to a positioning node for wireless communication in a cellular positioning system. The positioning node may include a memory and one or more processors coupled to the memory. The one or more processors may be configured to receive phase error related information associated with one or more carrier phase measurements obtained by one or more assisting nodes.

Some aspects described herein relate to a assisting node for wireless communication in a cellular positioning system. The assisting node may include a memory and one or more processors coupled to the memory. The one or more processors may be configured to obtain one or more carrier phase measurements. The one or more processors may be configured to transmit, to a positioning node, phase error related information associated with the one or more carrier phase measurements.

Some aspects described herein relate to a non-transitory computer-readable medium that stores a set of instructions for wireless communication by a positioning node in a cellular positioning system. The set of instructions, when executed by one or more processors of the positioning node, may cause the positioning node to receive phase error related information associated with one or more carrier phase measurements obtained by one or more assisting nodes.

Some aspects described herein relate to a non-transitory computer-readable medium that stores a set of instructions for wireless communication by an assisting node in a cellular positioning system. The set of instructions, when executed by one or more processors of the assisting node, may cause the assisting node to obtain one or more carrier phase measurements. The set of instructions, when executed by the one or more processors of the assisting node, may cause the assisting node to transmit, to a positioning node, phase error related information associated with the one or more carrier phase measurements.

Some aspects described herein relate to an apparatus for wireless communication in a cellular positioning system. The apparatus may include means for receiving phase error related information associated with one or more carrier phase measurements obtained by one or more assisting nodes.

Some aspects described herein relate to an apparatus for wireless communication in a cellular positioning system. The apparatus may include means for obtaining one or more carrier phase measurements. The apparatus may include means for transmitting, to a positioning node, phase error related information associated with the one or more carrier phase measurements.

Aspects generally include a method, apparatus, system, computer program product, non-transitory computer-readable medium, user equipment, base station, transmit receive point, location management function, positioning node, assisting node, reference node, target node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a positioning system that supports position estimation based on timing measurements and carrier phase measurements, in accordance with the present disclosure.

FIG. 4 is a diagram illustrating an example of single difference operations that may reduce or eliminate errors in timing measurements and/or carrier phase measurements used for positioning, in accordance with the present disclosure.

FIG. 5 is a diagram illustrating an example of a double difference operation that may reduce or eliminate errors in timing measurements and/or carrier phase measurements used for positioning, in accordance with the present disclosure.

FIG. 6 is a diagram illustrating examples of lane combinations that may reduce ambiguity searching overhead and/or reduce phase errors when using carrier phase measurements of multiple carriers to estimate a position, in accordance with the present disclosure.

FIGS. 7-8 are diagrams illustrating examples associated with assistance data for position estimation using carrier phase combination in a cellular positioning system, in accordance with the present disclosure.

FIGS. 9-10 are diagrams illustrating example processes associated with assistance data for position estimation using carrier phase combination in a cellular positioning system, in accordance with the present disclosure.

FIGS. 11-12 are diagrams of example apparatuses for wireless communication, in accordance with the present disclosure.

### DETAILED DESCRIPTION

In a wireless network, positioning functionality may be used to estimate the position or location of a target user equipment (UE) based on measurements associated with signals from a group of transmitters. For example, the estimated position or location of the target UE may be used to support an emergency service call, internally by the wireless network (e.g., for mobility management), or to provide other location-based or location-dependent services such as navigation assistance, direction finding, asset tracking, and/or smart metering, among other examples. In general, the position or location associated with the target UE may be estimated based at least in part on timing measurements associated with signals that are transmitted in one or more positioning systems. For example, one such positioning system may include a global navigation satellite system (GNSS) or satellite positioning system (SPS) that typically includes various satellites or other space vehicles orbiting the Earth (e.g., the Global Positioning System (GPS), Global Navigation Satellite System (GLONASS), and/or Galileo, among other examples). For example, in GNSS-based positioning, a UE may use pseudorandom codes in GNSS signals transmitted by at least four satellites to determine the time that each GNSS signal took to travel from the satellite to the UE. The UE may then determine a range (or distance) to each satellite (e.g., by multiplying the time that each GNSS signal took to travel from the satellite to the UE by the speed of light). The ranges or distances between the UE and the satellites are typically referred to as “pseudoranges” to account for errors in the timing measurements (e.g., due to satellite orbital error, satellite clock errors, and/or propagation errors, among other examples).

Another example system that may be used to estimate the position or location of a UE is a cellular positioning system that includes aerial and/or terrestrial base stations to support communications for various UEs. For example, a cellular positioning system may support Time Difference of Arrival (TDOA)-based positioning techniques, where a target UE may measure time differences in radio signals received from multiple base stations that have known positions. Accordingly, observed time differences in the signals received from the multiple base stations may be used to calculate the location of the UE. For example, in TDOA-based positioning, various base stations and/or transmit receive points (TRPs) may transmit a downlink reference signal (e.g., a positioning reference signal (PRS)), and the target UE may measure a time of arrival (TOA) for the downlink reference signals received from multiple base stations and/or TRPs. The UE may then subtract TOAs from one or more neighboring base stations or TRPs from a TOA of a reference node (e.g., a serving base station) to obtain reference signal time difference (RSTD) measurements, which determines multiple hyperbolas that intersect in a geometric area that represents an estimated position of the target UE. Accordingly, TDOA-based positioning techniques are a viable alternative positioning method that can be applied in many use cases, especially in harsh environmental conditions where GNSS signals are unavailable (e.g., indoors, in parking garages, and/or in tunnels). Nevertheless, TDOA-based positioning techniques present certain challenges.

For example, like GNSS-based positioning techniques, TDOA-based positioning in a cellular positioning system relies upon timing measurements that are subject to accuracy errors. For example, in GNSS-based positioning, satellite orbital errors, satellite clock errors, receiver clock errors, atmospheric propagation errors, and/or other errors may limit positioning accuracy to a few meters. Furthermore, in a cellular positioning system, positioning accuracy may be anywhere from a few meters to hundreds of meters depending upon network deployment (e.g., density or an extent to which base stations or TRPs are geographically dispersed, cell size, and/or adaptive antenna techniques, among other examples), UE capabilities, positioning method, and/or factors similar to those posed in GNSS-based positioning (other than atmospheric propagation errors such as ionospheric delay and/or tropospheric delays, which do not occur and can generally be ignored in cellular positioning systems). Accordingly, one technique that can be used to improve positioning accuracy in GNSS-based positioning techniques and/or cellular positioning techniques is the use of carrier phase measurements in a real-time kinematic (RTK) system. For example, when carrier phase measurements are used together with pseudorange measurements in GNSS-based positioning, a position estimate may approach centimeter or millimeter-level accuracy.

For example, an RTK system may leverage a carrier phase, without regard to information modulated on the carrier, and rely on fixed and well-surveyed physical reference nodes to transmit corrections data to in-range RTK-enabled target nodes (e.g., a target UE to be located). Because a given physical reference node is well-surveyed, an actual position of the physical reference node is known. Accordingly, the physical reference node may measure raw satellite data from the same group of satellites as the target node in order to determine corrections data that eliminates or mitigates errors common to the physical reference node and the target node. For example, using a carrier wave as a signal and ignoring information contained within the carrier wave, a range or distance to a satellite may be calculated by multiplying the carrier wavelength by an integer number of whole cycles between the satellite and the target node and adding a fractional phase difference. However, determining the integer number of whole cycles is complex and non-trivial, because transmitted signals may be shifted in phase by one or more cycles. Accordingly, positioning based on carrier phase measurements may result in an error equal to the error in the estimated number of cycles multiplied by the wavelength, which is 19 centimeters for a GPS L1 signal with a wavelength of 0.19 meters. The error may be reduced, resulting in centimeter or millimeter precision, by using an integer ambiguity resolver (IAR) algorithm to resolve the unknown integer cycle information in the carrier phase measurements. Furthermore, in a cellular positioning system, carrier phase measurements associated with multiple carriers may be combined to reduce a search overhead associated with the IAR algorithm and/or to improve positioning accuracy. However, because different carrier combinations may amplify and/or reduce errors in the original carrier phase measurements, the combined carrier phase measurements generally need to have a reasonable noise level for the IAR algorithm to work correctly.

Some aspects described herein relate to techniques and apparatuses that may provide a positioning node with assistance data for position estimation using carrier phase combination in a cellular positioning system. For example, in some aspects, the cellular positioning system may support UE-assisted position estimation, where a target UE to be located and a reference node (e.g., a base station, TRP, or reference UE) may act as assisting nodes to obtain carrier phase measurements for one or more carriers and report phase error related information to a location management function (LMF) acting as the positioning node. Additionally, or alternatively, the cellular positioning system may support UE-based position estimation, where the target UE to be located may act as the positioning node and a reference node (e.g., a base station, TRP, or reference UE) may act as an assisting node to provide phase error related information associated with carrier phase measurements to the target UE (e.g., over a direct link or relayed through the LMF or another core network device). In general, the assisting node may provide the phase error related information to the positioning node in a measurement report that includes the carrier phase measurements, whereby the positioning node may use the phase error related information to resolve integer cycle information associated with the carrier phase measurements and thereby refine a coarse position estimate of the target UE (e.g., by selecting a carrier phase combination that minimizes a combined error in the combined carrier phase measurements). Additionally, or alternatively, the assisting node may provide the phase error related information to the positioning node as assistance data that indicates the carrier phase combination method and/or variance of noise in the original carrier phase measurements obtained by the assisting node. Furthermore, in cases where the positioning node is an LMF, the LMF may use the phase error related information to determine a PRS configuration that may minimize phase error in the carrier phase measurements. In this way, carrier phase measurements based on RTK principles may be used to improve position estimation accuracy and/or reduce positioning resource overhead in a cellular positioning system.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

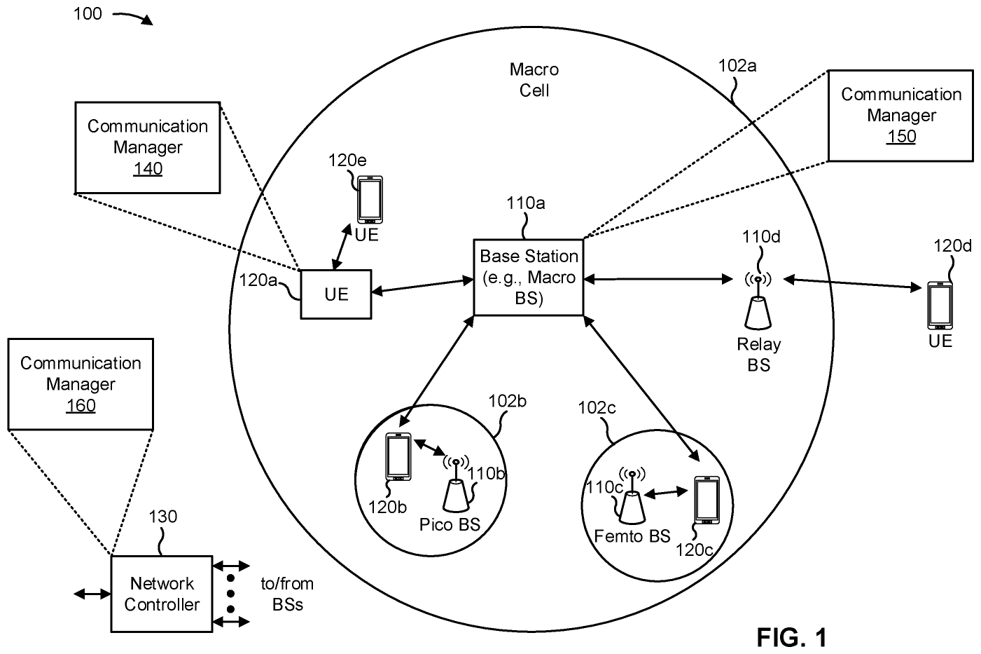

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a UE 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a TRP. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link. In some aspects, the network controller 130 may include one or more devices in a core network (e.g., a location management function (LMF)).

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, when the UE 120 is configured as a positioning node in a cellular positioning system, the communication manager 140 may receive phase error related information associated with one or more carrier phase measurements obtained by one or more assisting nodes. Additionally, or alternatively, when the UE 120 is configured as an assisting node in a cellular positioning system, the communication manager 140 may obtain one or more carrier phase measurements; and transmit, to a positioning node, phase error related information associated with the one or more carrier phase measurements. Additionally, or alternatively, the communication manager 140 may perform one or more other operations described herein.

In some aspects, the base station 110 may include a communication manager 150. As described in more detail elsewhere herein, when the base station 110 is configured as an assisting node in a cellular positioning system, the communication manager 150 may obtain one or more carrier phase measurements; and transmit, to a positioning node, phase error related information associated with the one or more carrier phase measurements. Additionally, or alternatively, the communication manager 150 may perform one or more other operations described herein.

In some aspects, the network controller 130 may include a communication manager 160. As described in more detail elsewhere herein, when the network controller 130 is configured as a positioning node in a cellular positioning system (e.g., the network controller 130 includes an LMF), the communication manager 160 may receive phase error related information associated with one or more carrier phase measurements obtained by one or more assisting nodes. Additionally, or alternatively, the communication manager 160 may perform one or more other operations described herein.

As indicated above, FIG. 1 is provided as an example. Other examples may differ from what is described with regard to FIG. 1.

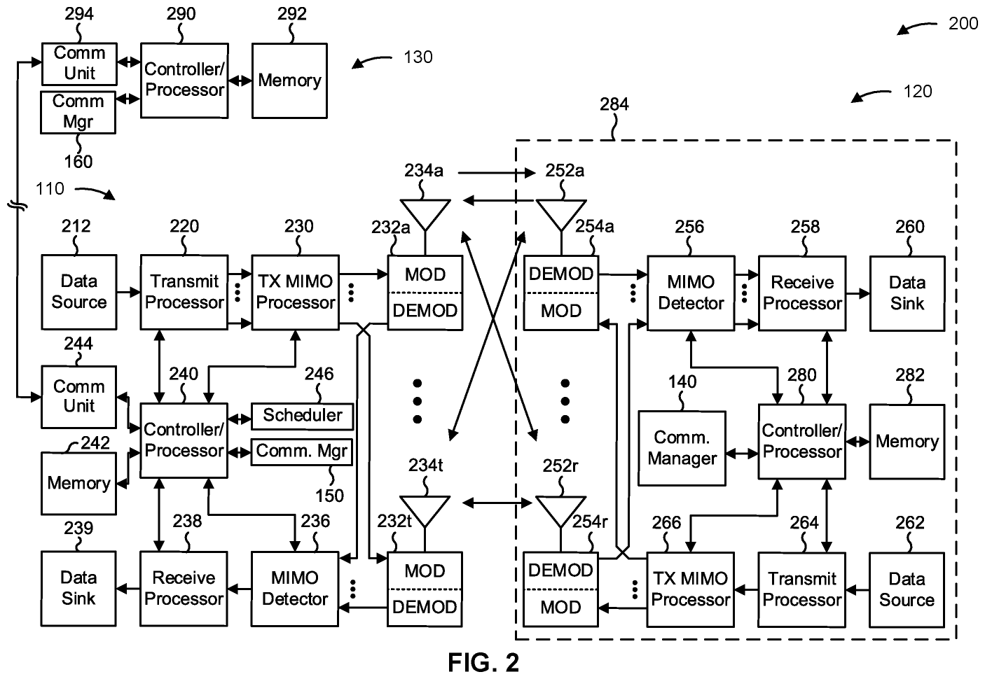

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network (e.g., an LMF). The network controller 130 may communicate with the base station 110 and/or the UE 120 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

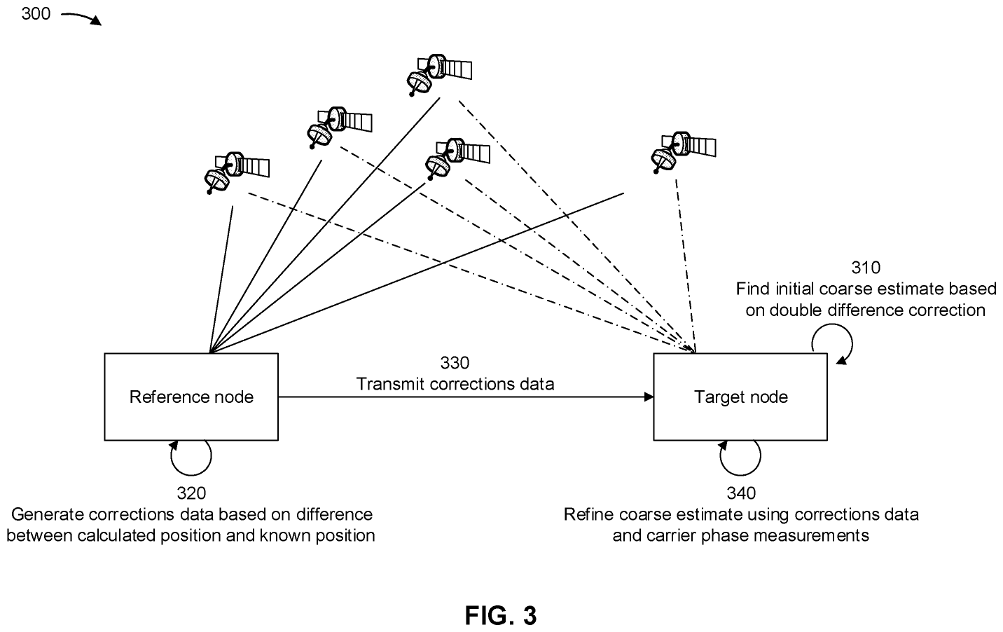

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-12).

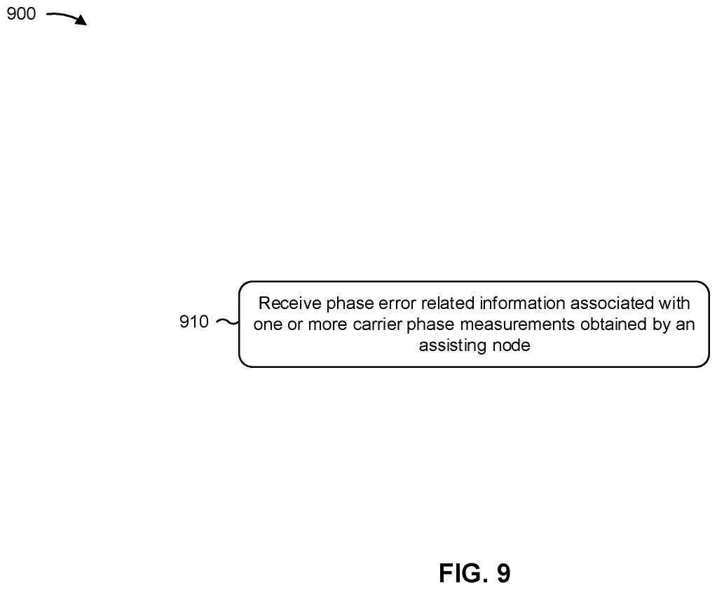

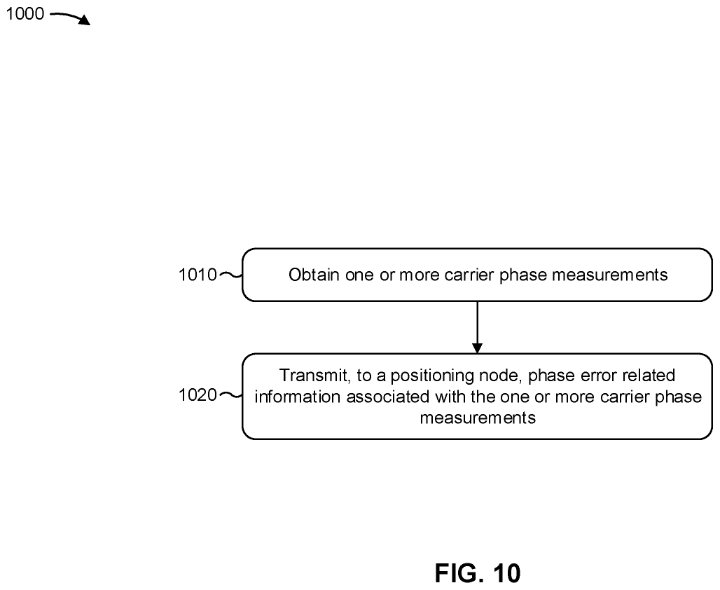

The controller/processor 240 of the base station 110, the controller/processor 280 of the UE 120, and/or any other component(s) of FIG. 2 may perform one or more techniques associated with assistance data for position estimation using carrier phase combination in a cellular positioning system, as described in more detail elsewhere herein. In some aspects, the cellular positioning system may support UE-based position estimation using carrier phase combination, in which case a positioning node described herein is the UE 120, is included in the UE 120, or includes one or more components of the UE 120 shown in FIG. 2. Additionally, or alternatively, the cellular positioning system may support UE-assisted position estimation using carrier phase combination, in which case the positioning node described herein is the network controller 130, is included in the network controller 130, or includes one or more components of the network controller 130 shown in FIG. 2. Furthermore, in UE-based position estimation and/or UE-assisted position estimation using carrier phase combination, an assisting node described herein is the base station 110 and/or the UE 120, is included in the base station 110 and/or the UE 120, or includes one or more components of the base station 110 and/or the UE 120 shown in FIG. 2. For example, the controller/processor 240 of the base station 110, the controller/processor 280 of the UE 120, the controller/processor 290 of the network controller 130, and/or any other component(s) of FIG. 2 may perform or direct operations of, for example, process 900 of FIG. 9, process 1000 of FIG. 10, and/or other processes as described herein. The memory 242, the memory 282, and/or the memory 292 may store data and program codes for the base station 110, the UE 120, and the network controller 130, respectively. In some examples, the memory 242, the memory 282, and/or the memory 292 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110, the UE 120, and/or the network controller 130, may cause the one or more processors, the base station 110, the UE 120, and/or the network controller 130 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the positioning node includes means for receiving phase error related information associated with one or more carrier phase measurements obtained by one or more assisting nodes. In some aspects, the means for the positioning node to perform operations described herein may include, for example, one or more of communication manager 140, antenna 252, modem 254, MIMO detector 256, receive processor 258, transmit processor 264, TX MIMO processor 266, controller/processor 280, or memory 282. In some aspects, the means for the positioning node to perform operations described herein may include, for example, one or more of communication manager 160, communication unit 294, controller/processor 290, or memory 292.

In some aspects, the assisting node includes means for obtaining one or more carrier phase measurements; and/or means for transmitting, to a positioning node, phase error related information associated with the one or more carrier phase measurements. In some aspects, the means for the assisting node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the assisting node to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of a positioning system that supports position estimation based on timing measurements and carrier phase measurements, in accordance with the present disclosure. As shown in FIG. 3 and described in further detail herein, the positioning system includes a group of transmitters, a target node to be located, and a reference node. For example, in FIG. 3, the group of transmitters may include a satellite constellation in a global navigation satellite system (GNSS), such as GPS, GLONASS, and/or Galileo, among other examples. However, it will be appreciated that the positioning techniques described herein may be applied in other positioning systems, such as a cellular positioning system that uses TDOA measurements to estimate the position of a target node.

In some aspects, the positioning system shown in FIG. 3 may use timing measurements in addition to carrier phase measurements in order to increase positioning accuracy to a centimeter-level accuracy or better. For example, when configured as a GNSS-based positioning system, the timing measurements may include pseudoranges that generally have a measurement error of a few meters depending on a code phase chip length, defined as 1/chipping_rate (e.g., 300 meters (m) for a GPS L1 signal). For example, the measurement error may be in a range from approximately one thousandth to approximately one hundredth the chip length, or 0.3-3.0 m for a GPS L1 signal. Accordingly, for applications that require higher accuracies, carrier phase measurements may be used based on a real-time kinematic (RTK) technique, which can improve positioning accuracy to a centimeter level or better. For example, carrier phase measurements may use a carrier wave as a signal without regard to information contained within the carrier wave, whereby a range or distance to a transmitter may be calculated by multiplying the wavelength of the carrier wave by an integer number of full cycles between the transmitter and the target node and adding a fractional phase difference. Accordingly, positioning based on carrier phase measurements may be associated with a measurement error based on the carrier phase wavelength (e.g., approximately one hundredth of the wavelength, or 1.9 millimeters for the GPS L1 signal having a 19 centimeter wavelength). For example, in order to estimate a position of a target node (e.g., a target UE) using carrier phase measurements, at least one reference node (e.g., a base station, TRP, or reference UE) having a known position may measure the same positioning signals (e.g., satellite signals in a GNSS and/or PRSs in a cellular positioning system) as the target node. The reference node can then compare the position estimate obtained from the positioning signals and the known position of the reference node to determine the difference and eliminate or mitigate errors in the positioning signals. For example, errors that may be eliminated or mitigated from GNSS signals may include imperfect satellite orbits, satellite clock errors, atmospheric propagation errors (e.g., ionospheric delay and/or tropospheric delay), and/or other errors that may contribute inaccuracies to the GNSS signals by the time that the GNSS signals reach the receiver. The reference node may then provide corrections data to the target node to improve the accuracy of range-related estimations. Additionally, or alternatively, the reference node may share the positioning signal measurements obtained by the reference node directly with the target node, in which case the corrections data provided to the target node may include the positioning signal measurements obtained by the reference node.

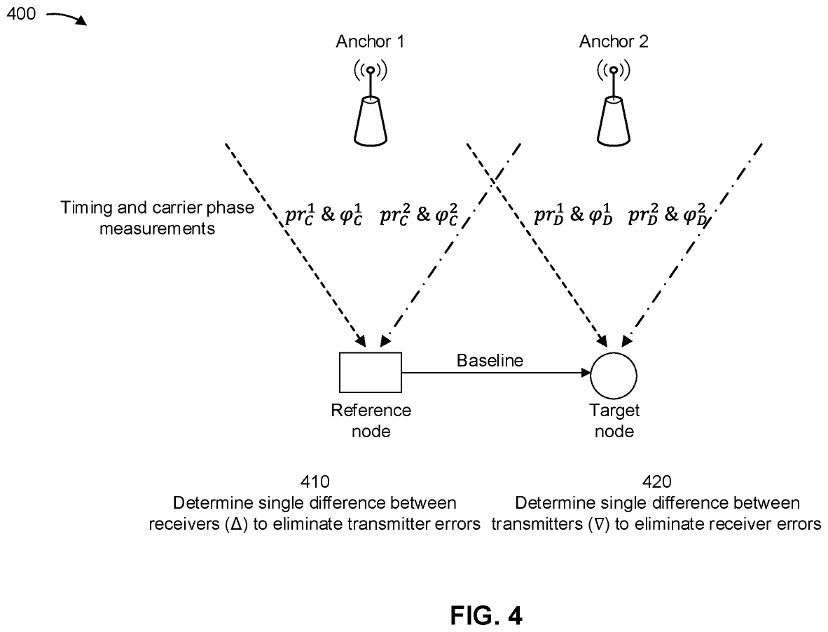

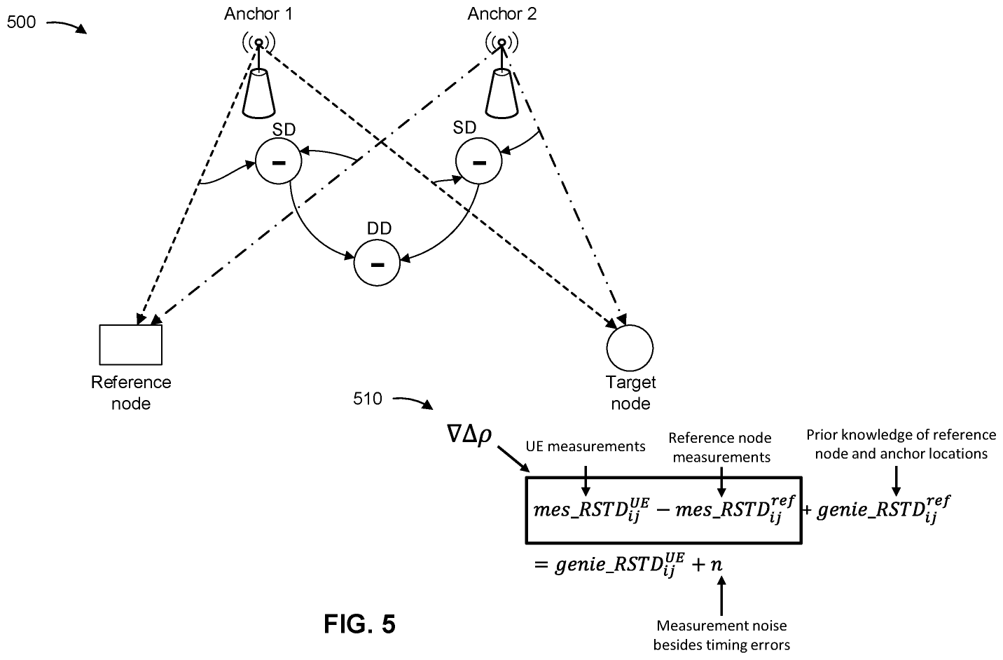

For example, as shown by reference number 310, the target node may receive positioning signals from a group of transmitters (e.g., at least three transmitters to resolve a position in two coordinates, or at least four transmitters to resolve a position in three coordinates), and the target node may obtain timing measurements and carrier phase measurements based on the positioning signals. For example, the timing measurements may include pseudoranges in a GNSS-based positioning system or reference signal time difference (RSTD) measurements in a cellular positioning system that uses time difference of arrival (TDOA) positioning techniques. The target node may then apply a double difference correction technique (e.g., as described in further detail with reference to FIGS. 4-5) to eliminate errors and/or biases in the timing measurements, and may find an initial coarse estimate of the target node based on the timing measurements. Furthermore, as shown by reference number 320, the reference node may obtain timing measurements and carrier phase measurements based on the same positioning signals observed by the target node, and may generate corrections data that eliminates or mitigates errors from the positioning signals. As shown by reference number 330, the reference node may transmit the corrections data to the target node (e.g., via a direct radio link or relayed through another device). Accordingly, as shown by reference number 340, the target node may use the initial coarse estimate, the carrier phase measurements, and the corrections data to improve the initial range-related estimation. Alternatively, in a UE-assisted positioning technique, an LMF (not shown) may act as a positioning node to determine the initial coarse estimate of the target UE and to refine the coarse estimate based on timing measurements and carrier phase measurements reported by the target node and the reference node.

When using carrier phase measurements to refine an initial (range-related) coarse position estimate, a range or distance to a transmitter may be calculated by multiplying the carrier wavelength by an integer number of whole cycles between the satellite and the target node and adding a fractional phase difference. Accordingly, because the transmitted positioning signals may be shifted in phase by one or more cycles, a positioning node (e.g., the target node in UE-based positioning or an LMF in UE-assisted positioning) may need to use an integer ambiguity resolver (IAR) algorithm to resolve unknown integer cycle information in the carrier phase measurements.

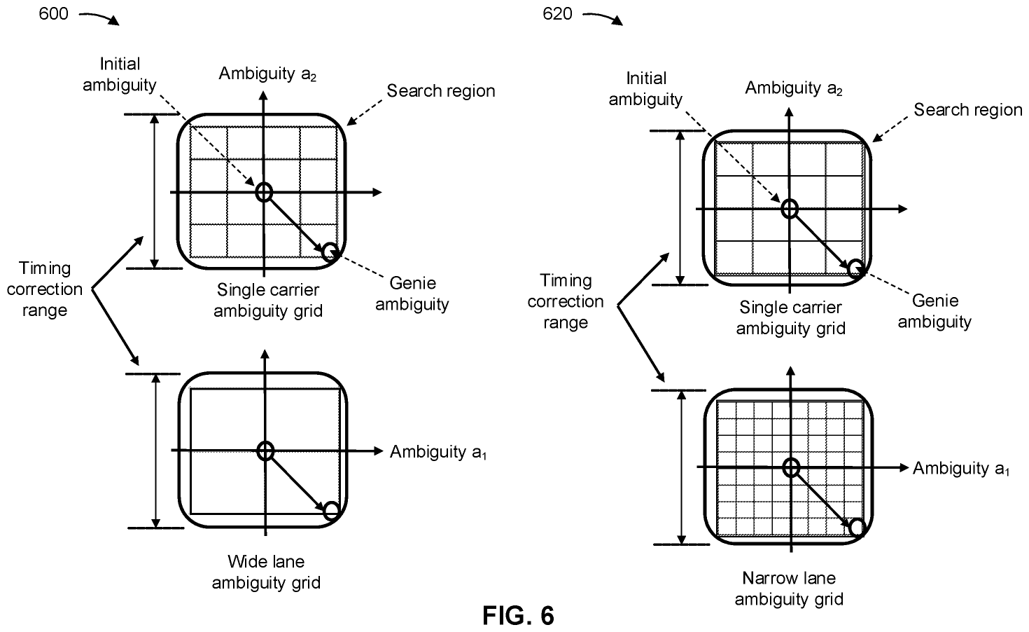

In general, the techniques described herein to improve position estimation accuracy based on a combination of timing measurements and carrier phase measurements may be applied on a single carrier (e.g., the L1, L2, or L5 band for GPS). Additionally, or alternatively, multiple carriers may be combined (e.g., L1 and L2, L1 and L5, or L2 and L5) to reduce the search overhead associated with the IAR algorithm and/or to improve positioning accuracy. For example, as described in further detail below with reference to FIG. 6, wide laning may be used to combine multiple GNSS carriers in a way that may reduce the search overhead associated with the IAR algorithm at the cost of amplifying phase errors, or narrow laning may be used to combine multiple GNSS carriers in a way that may reduce phase errors at the cost of increasing the search overhead associated with the IAR algorithm. Furthermore, some aspects described herein may use similar techniques to combine carriers in a cellular positioning system (e.g., in carrier phase combination). For example, in a cellular positioning system, carrier phase based positioning can assign a PRS to any suitable component carrier, frequency band, and/or positioning frequency layer (e.g., in contrast to GNSS signals, which are generally limited to a few frequencies). However, because different carrier combinations may amplify and/or reduce errors in the original carrier phase measurements, the combined carrier phase measurements generally need to have a reasonable noise level for the IAR algorithm to work correctly (e.g., to avoid degrading the positioning accuracy and/or introducing excessive integer ambiguity search overhead). Accordingly, some aspects described herein relate to techniques and apparatuses for providing assistance data for carrier phase combination in a cellular positioning system. For example, as described herein, the assistance data may indicate a carrier combination method and/or noise variance in original carrier phase measurements, which may allow a positioning node (e.g., an LMF in UE-assisted positioning or a target UE in UE-based positioning) to refine a position estimate for a target node and/or configure a PRS to improve position estimation in the cellular positioning system.

As indicated above, FIG. 3 is provided as an example. Other examples may differ from what is described with regard to FIG. 3.

FIG. 4 is a diagram illustrating an example 400 of single difference operations that may reduce or eliminate errors in timing measurements and/or carrier phase measurements used for positioning, in accordance with the present disclosure. As shown in FIG. 4, example 400 includes a target node (e.g., a target UE whose position is to be estimated) and a reference node (e.g., a base station, TRP, or reference UE) having a known position. In some aspects, the target node and the reference node may each measure positioning signals transmitted by the same set of transmitters, which may include at least a first anchor node and a second anchor node (shown as anchor 1 and anchor 2). As described in further detail herein, the reference node and the target node may each obtain carrier phase measurements and timing measurements based on the positioning signals transmitted by the set of transmitters, which may be used in combination to provide a precise position estimate for the target node.

In some aspects, as described herein, carrier phase measurements are based on the general principle that any range or distance (e.g., from a receiver to a transmitter) may be calculated by multiplying a wavelength of a carrier wave by an integer number of full cycles between the transmitter and the receiver and adding a fractional carrier phase, as shown in the following expression:

$$λ ( \frac{θ ( t ) - {θ}_{0}}{2 π} + N ) = ρ$$

where ρ is the range or distance between the transmitter (e.g., anchor 1 or anchor 2) and the receiver (e.g., the reference node or the target node), λ is the carrier phase wavelength (in meters), θ=θ(t)−θ₀ is the fractional carrier phase, θ(t) is a carrier phase measured at the receiver, θ₀ is the initial carrier phase at the transmitter, and N is the integer number of full cycles for the carrier wave between the transmitter and the receiver. In some aspects, the receiver needs to use an IAR algorithm to determine a value for N, which is unknown and cannot be measured directly. Furthermore, the above expression generally applies in ideal conditions, without any transmitter errors, receiver errors, and/or propagation errors. Accordingly, the above expression to represent the range, ρ, may be modified as follows to incorporate timing errors and/or location errors:

$$λ ( \frac{θ}{2 π} + N ) = ρ + c ( dt - dT ) + {ε}_{φ} + d ρ$$

where c is the speed of light, dt is a transmitter clock error (in seconds), dT is a receiver clock error, ε_{φ} is a carrier phase noise and multipath (in meters), and dρ is an anchor location error (e.g., an orbit error in a GNSS. Furthermore, in a GNSS, there may be atmospheric propagation errors, such as ionospheric delay and/or tropospheric delay. However, as described herein, atmospheric propagation errors may apply only to GNSS signals and not to a PRS or other downlink signal used for positioning in a cellular positioning system based on TDOA or RSTD measurements. Any equations described herein that are applicable to cellular positioning systems may therefore exclude propagation errors that are specific to GNSS positioning. Accordingly, because the integer number of full cycles, N, is unknown and cannot be measured directly, a carrier phase measurement φ (in meters) in a cellular positioning system may be determined by moving the unknown variable N to the other side of the equation, as follows:

$$φ = λ \frac{θ}{2 π} = ρ + c ( dt - dT ) - λ N + {ε}_{φ}$$

In this way, a receiver may directly measure the carrier wavelength λ and the fractional carrier phase θ, and may further resolve the distance ρ to the transmitter by eliminating or mitigating errors from the carrier phase measurement and solving for the integer number of full cycles using the IAR algorithm. Furthermore, a resolution of the carrier phase measurement may be determined by the carrier wavelength and the fractional carrier phase measurement, which results in a much finer resolution than a pseudorange.

For example, as described herein, the term “pseudorange” generally refers to a measurement that represents a pseudo distance between a satellite that transmits a GNSS signal and a receiver that receives and measures the GNSS signal. In particular, a pseudorange represents a pseudo distance (rather than an actual distance) because timing measurements performed at the receiver will include clock errors due to clock synchronization differences between a satellite clock and a receiver clock. At the receiver, the clock time at the receiver is typically used to simultaneously or concurrently measure several ranges that have the same error(s), where pseudoranges may include the various ranges with the same error(s). In this context, a pseudorange measurement model that incorporates errors(s) in the timing measurements may be represented using the following expression:

pr=ρ+c(dt−dT)+εₚ

where pr is a pseudorange measurement and εₚ is pseudorange noise and multipath (in meters). Accordingly, relative to a carrier phase measurement that has a very fine resolution (e.g., a centimeter or millimeter-level accuracy based on a carrier wavelength and/or fractional carrier phase), pseudoranges are coarse estimates (e.g., with a best-case accuracy of a few meters). However, whereas carrier phase measurements are ambiguous due to the need to use an IAR algorithm to solve for the integer number of full cycles, N, pseudoranges are unambiguous.

Accordingly, in a cellular positioning system with atmospheric propagation errors removed to simplify the measurement models, carrier phase and timing measurement models incorporating timing and location errors observed at the receiver may be represented as follows:

pr=ρ+c(dt−dT)+εₚ

φ=ρ+c(dt−dT)+ε_{φ}−λN

whereby the receiver may need to eliminate transmitter and/or receiver errors from the measurements and solve the carrier phase integer ambiguity or integer number of cycles, N, in order to estimate the range, ρ, between the receiver and the transmitter. For example, as described in further detail herein, the receiver may use one or more differencing techniques to eliminate the errors from the measurements.

For example, as shown in FIG. 4, the reference node and the target node may each obtain a set of timing measurements and a set of carrier phase measurements for positioning signals transmitted by a set of transmitters. For example, as described herein, the timing measurements may include pseudoranges for GNSS positioning signals or RSTD measurements for positioning signals in a cellular positioning system (e.g., a PRS or other suitable downlink signal). Furthermore, the carrier phase measurements may include a fractional carrier phase, θ, which equals a difference between a carrier phase measured at the receiver (e.g., the reference node or the target node) and an initial carrier phase at the transmitter. Accordingly, as shown in FIG. 4, and by reference number 410, the reference node and/or the target node may determine a single difference between receivers (represented herein as a Δ operator) to eliminate transmitter errors from the timing measurements and the carrier phase measurements.

For example, as shown in FIG. 4, the reference node and the target node may each obtain a timing measurement and a carrier phase measurement associated with a positioning signal transmitted by the first anchor node, where pr_{C}¹ represents the timing measurement obtained by the reference node for the positioning signal transmitted by the first anchor node, φ_{C}¹ represents the carrier phase measurement obtained by the reference node for the positioning signal transmitted by the first anchor node, pr_{D}¹ represents the timing measurement obtained by the target node for the positioning signal transmitted by the first anchor node, and φ_{D}¹ represents the carrier phase measurement obtained by the target node for the positioning signal transmitted by the first anchor node. Accordingly, to determine the single difference between the receivers, the measurement obtained by the reference node for a particular transmitter may be subtracted from the measurement obtained by the target node for the same transmitter in order to eliminate the transmitter clock error, dt, and to eliminate the transmitter initial phase, θ₀, from the timing and carrier phase measurements, whereby the following expressions may represent single differences between the receivers for the timing measurement and the carrier phase measurement from a particular transmitter:

Δpr=Δρ−cΔdT+ε_{Δp} (GNSS positioning)

RSTD_{C}^{1,2=pr}_{C}^{1-pr}_{C}² (TDOA-based positioning)

Δφ=Δρ+cΔdT−λΔN+ε_{Δφ}

As further shown in FIG. 4, and by reference number 420, the reference node and/or the target node may further determine a single difference between transmitters (represented herein as a ∇ operator) to eliminate receiver errors from the timing measurements and the carrier phase measurements. For example, in addition to obtaining a timing measurement and a carrier phase measurement associated with a positioning signal transmitted by the first anchor node, the reference node and the target node may each obtain a timing measurement and a carrier phase measurement associated with a positioning signal transmitted by the second anchor node. For example, in FIG. 4, pr_{C}² represents the timing measurement obtained by the reference node for the positioning signal transmitted by the second anchor node, φ_{C}² represents the carrier phase measurement obtained by the reference node for the positioning signal transmitted by the second anchor node, pr_{D}², represents the timing measurement obtained by the target node for the positioning signal transmitted by the second anchor node, and φ_{D}² represents the carrier phase measurement obtained by the target node for the positioning signal transmitted by the second anchor node. Accordingly, to determine the single difference between the transmitters (e.g., the first anchor node and the second anchor node), the measurement that a particular receiver (e.g., the reference node and/or target node) obtains for a first transmitter (e.g., the first anchor node) may be subtracted from a base measurement that the receiver obtained for a second transmitter (e.g., the second anchor node) in order to eliminate the receiver clock error, dT, and to eliminate common hardware bias in the receiver (e.g., similar to an RSTD measurement in a cellular positioning system). Accordingly, the following expressions may represent single differences between transmitters for timing measurements and carrier phase measurements obtained by a particular receiver:

RSTD=∇pr=∇ρ+c∇dt+ε_{Δp}

∇φ=∇ρ+c∇dt−N+ε_{∇φ}

As indicated above, FIG. 4 is provided as an example. Other examples may differ from what is described with regard to FIG. 4.

FIG. 5 is a diagram illustrating an example of a double difference operation that may reduce or eliminate errors in timing measurements and/or carrier phase measurements used for positioning, in accordance with the present disclosure. As shown in FIG. 5, example 500 includes a target node (e.g., a target UE whose position is to be estimated) and a reference node (e.g., a base station, TRP, or reference UE) having a known position. In some aspects, the target node and the reference node may each measure positioning signals transmitted by the same set of transmitters, which may include at least a first anchor node and a second anchor node (shown as anchor 1 and anchor 2). As described in further detail herein, the reference node and the target node may each obtain carrier phase measurements and timing measurements based on the positioning signals transmitted by the set of transmitters, which may be used in combination to provide a precise position estimate for the target node.

In some aspects, the position estimate for the target node may be determined based on a combination of timing measurements and carrier phase measurements obtained by the reference node and the target node. For example, as described herein, the reference node and/or the target node may determine the position estimate by determining a double difference between receivers and transmitters (represented herein as a Δ∇ operator) to eliminate transmitter and receiver errors from the timing measurements and the carrier phase measurements. For example, a first single difference between transmitters may be determined based on a difference between timing measurements obtained by the same receiver for the first and second anchor nodes, providing an RSTD measurement that may be used for positioning, and a second single difference between receivers may be determined based on a difference between measurements obtained by the reference node and the target node for the same anchor node. Accordingly, the double difference between the receivers and the transmitters may be determined based on a difference between the first single difference and the second single difference, whereby double differences for the timing measurements and the carrier phase measurements may be represented using the following expressions:

Δpr=Δ∇ρ+ε_{Δ∇p}

∇Δφ=∇Δρ−λ∇ΔN+ε_{∇Δφ}

Accordingly, in some aspects, the double difference operation may eliminate the transmitter clock error, dt, and the receiver clock error, dT. However, the double difference operation for the carrier phase measurement includes the term λ∇ΔN, which represents the unknown integer ambiguity (based on the number of full cycles) that needs to be estimated using an IAR algorithm. In this case, based on the double difference measurement for the carrier phase, ∇Δφ, and the estimated value of VAN determined using the IAR algorithm, a precise estimate for ∇Δρ may be determined. Furthermore, as shown by reference number 510, the precise estimate for ∇Δρ can be used in combination with prior knowledge of the position of the reference node and the positions of the transmitters (e.g., the anchor nodes) to provide a precise final RSTD estimation in a TDOA-based positioning in a cellular positioning system (e.g., based on a genie RSTD between the reference node and two transmitters or anchor nodes). In this way, the precise estimate for ∇Δρ and the genie RSTD between the reference node and two anchor nodes can provide a genie RSTD between the target node and the same two anchor nodes with measurement noise that excludes the timing errors eliminated by the double difference operation.

As indicated above, FIG. 5 is provided as an example. Other examples may differ from what is described with regard to FIG. 5.

FIG. 6 is a diagram illustrating examples 600, 620 of lane combinations that may reduce ambiguity searching overhead and/or reduce phase errors when using carrier phase measurements of multiple carriers to estimate a position, in accordance with the present disclosure. For example, as described in further detail above, using carrier phase measurements to estimate a position may generally depend on using an IAR algorithm to solve for the variable N, which represents an integer number of full cycles associated with a carrier wave during transmit from a transmitter to a receiver. Accordingly, as described in further detail herein, example 600 illustrates a widelane combination that may be used in GNSS positioning to reduce ambiguity searching overhead for the IAR algorithm due to a larger effective wavelength at a cost of amplifying phase errors, and example 620 illustrates a narrowlane combination that may be used in GNSS positioning to reduce phase errors at a cost of increasing ambiguity searching overhead for the IAR algorithm due to a smaller effective wavelength.

For example, referring to example 600, a widelane combination in GNSS positioning is based on a combined GNSS signal (e.g., combining GPS signals L1 and L2 or L1 and L5, GLONASS signals G1 and G2 or G1 and G3, and/or Galileo signals E1 and E5b or E5b and E5a, among other examples). In a widelane combination, the combined GNSS signal has a combined wavelength that is larger than the largest individual wavelength in the widelane combination. For example, in a widelane combination of a first GNSS signal having a first frequency, f₁, and a second GNSS signal having a second frequency, f₂, the wavelength of the widelane combination, λ_{w}, may be given by c/(f₁−f₂). Accordingly, in cases where |f₁−f₂|<f₂ and |f₁-f₂| <f₁, the combined wavelength can be than the largest individual wavelength in the widelane combination larger and the combined measurement error may be represented as follows:

$$\frac{{f}_{1} {ε}_{{φ}_{L 1}} - {f}_{2} {ε}_{{φ}_{L 2}}}{{f}_{1} - {f}_{2}}$$

In some aspects, a widelane combination may be useful for ambiguity resolution algorithms, such as the IAR algorithm that is used to solve for the integer number of full cycles associated with a carrier wave, as well as cycle-slip and/or outlier detection. For example, as described herein, a widelane combination may reduce ambiguity searching overhead due to the larger effective wavelength. However, the reduced ambiguity searching overhead comes with a trade-off, in that a widelane combination amplifies phase errors and/or other noise that may be present in the original measurements. For example, given a single carrier fᵢ having a wavelength of

$$\frac{c}{{f}_{i}} ,$$

a widelane combination of a first carrier and a second carrier may have a wavelength given by

$$\frac{c}{\vert {f}_{1} - {f}_{2} \vert} .$$

Accordingly, given me same timing correction range, an integer ambiguity search overhead ratio between the single carrier fᵢ and the widelane combination is given by

$$\frac{{f}_{i}}{\vert {f}_{1} - {f}_{2} \vert} .$$

example, as shown in rig. 6, and by example 600, a first integer ambiguity grid is shown for a single carrier, and a second integer ambiguity grid is shown for a widelane combination of a first carrier and a second carrier. As shown, each integer ambiguity grid may include a search region and two ambiguities (e.g., an initial ambiguity and a genie ambiguity) based on two double difference measurements, where each ambiguity represents the unknown integer number of full cycles for an associated double difference measurement. In general, the IAR algorithm may include searching the search region in order to find the genie ambiguity, starting from the initial ambiguity at the center of the integer ambiguity grid. Accordingly, as shown by example 600, the IAR algorithm may need to move two blocks from the initial ambiguity to find the genie ambiguity and thereby estimate the integer number of full cycles for a single carrier. In contrast, as shown in the second integer ambiguity grid for the widelane combination, the IAR algorithm may need to move only one block to find the genie ambiguity given the same timing correction range due to the larger effective wavelength (e.g., the integer ambiguity grid is reduced from a 4×4 grid in the case of a single carrier to a 2×2 grid for a widelane combination in the illustrated example, which significantly reduces the number of hypotheses that the IAR algorithm needs to test before arriving at the genie ambiguity). It will be appreciated, however, that the ambiguity grids (including the grid ratios and/or grid sizes) are examples only for demonstration and explanation, and that various aspects described herein contemplate other configurations for the ambiguity grids.

However, despite reducing the ambiguity searching overhead of the IAR algorithm used to solve for the integer number of full cycles in carrier phase measurement, a widelane combination in GNSS positioning may amplify phase errors in the original carrier phase measurements. For example, the combined measurement error for a widelane combination of two GNSS signals may be represented as follows:

$$\frac{{a}_{1} {f}_{1} {ε}_{{φ}_{L 1}} - {a}_{2} {f}_{2} {ε}_{{φ}_{L 2}}}{{a}_{1} {f}_{1} - {a}_{2} {f}_{2}}$$

where aᵢ is an integer coefficient that scales the carrier phase measurement error ε_{φ}_{_{Li}} associated with a carrier fᵢ. In this case, the variance of the carrier phase measurement errors ε_{φ}_{_{L1}}, ε_{φ}_{_{L2}} may be represented as σ_{φ}_{_{L1}}², σ_{φ}_{_{L2}}², and the variance of the combined measurement error for the widelane combination is:

$${σ}_{{φ}_{W L}}^{2} = {( \frac{{a}_{1} {f}_{1}}{{a}_{1} {f}_{1} - {a}_{2} {f}_{2}} )}^{2} {σ}_{{φ}_{L 1}}^{2} + {( \frac{{a}_{2} {f}_{2}}{{a}_{1} {f}_{1} - {a}_{2} {f}_{2}} )}^{2} {σ}_{{φ}_{L 2}}^{2}$$

Accordingly, as shown in the above expression for representing the variance of the combined measurement error, σ_{φ}_{_{WL}}², the original carrier phase measurement errors are scaled by the integer coefficients a₁ and a₂ associated with the respective carriers that are combined in the widelane combination, thus amplifying the carrier phase measurement errors. As a result, when a positioning entity is performing an IAR algorithm based on widelane combination, the positioning entity may be configured to select a widelane combination that has a wider combined wavelength to reduce the ambiguity searching overhead while also minimizing a combined phase error (e.g., by selecting a combination of signals that provides a large combined wavelength and a small combined phase error based on the combined carriers, f₁, f₂, and the variance of the associated measurement errors σ_{φ}_{_{L1}}², σ_{φ}_{_{L2}}².

Additionally, or alternatively, referring to example 620, a narrowlane combination in GNSS positioning is based on a combined GNSS signal having a combined wavelength that is smaller than the smallest individual wavelength in the narrowlane combination, in a narrowlane combination of a first GNSS signal having a first frequency, f₁, and a second GNSS signal having a second frequency, f₂, the wavelength of the narrowlane combination, λ_{N}, may be given by c/(f₁+f₂). Accordingly, similar to a widelane combination, the combined measurement noise for a narrowlane combination is:

$$\frac{{f}_{1} {ε}_{{φ}_{L 1}} + {f}_{2} {ε}_{{φ}_{L 2}}}{{f}_{1} + {f}_{2}}$$

and the combination can be generalized as:

$$\frac{{a}_{1} {f}_{1} * {φ}_{L 1} + {a}_{2} {f}_{2} * {φ}_{L 2}}{{a}_{1} {f}_{1} + {a}_{2} {f}_{2}}$$

where a₁ and a₂ are integer coefficients. In some aspects, a narrowlane combination may be useful for finer positioning accuracy, as the smaller effective wavelength may reduce measurement noise present in the original carrier phase measurements. However, the narrowlane combination may increase the ambiguity searching overhead of the IAR algorithm. For example, given a single carrier fᵢ having a wavelength of

$$\frac{c}{{f}_{i}} ,$$

a narrowlane combination of a first carrier and a second carrier may have a wavelength given by

$$\frac{c}{\vert {f}_{1} - {f}_{2} \vert} .$$

Accordingly, given the same timing correction range, an integer ambiguity search overhead ratio between the single carrier fᵢ and the narrowlane combination is

$$\frac{{f}_{i}}{\vert {f}_{1} - {f}_{2} \vert} .$$

For example, in FIG. 6, example 620 shows a first integer ambiguity grid for a single carrier that is the same as described above with reference to widelane combinations, and a second integer ambiguity grid is shown for a narrowlane combination of a first carrier and a second carrier. As shown, each integer ambiguity grid includes a search region and two ambiguities (e.g., an initial ambiguity and a genie ambiguity) based on two double difference measurements, where each ambiguity represents the unknown integer number of full cycles for an associated double difference measurement. In this case, as shown in the second integer ambiguity grid for the narrowlane combination, the IAR algorithm may need to move four blocks to find the genie ambiguity given the same timing correction range as a single carrier due to the smaller effective wavelength (e.g., the integer ambiguity grid is increased from a 4×4 grid in the case of a single carrier to a 16×16 grid for a narrowlane combination in the illustrated example, which significantly increases the overhead to cover the same timing correction range by increasing the number of hypotheses that the IAR algorithm needs to test before arriving at the genie ambiguity).

However, in a narrowlane combination, a tradeoff for the increased ambiguity searching overhead of the IAR algorithm is that phase errors in the original carrier phase measurements are reduced. For example, the combined measurement error for a narrowlane combination of two GNSS signals may be represented as follows:

$$\frac{{a}_{1} {f}_{1} * {ε}_{{φ}_{L 1}} + {a}_{2} {f}_{2} * {ε}_{{φ}_{L 2}}}{{a}_{1} {f}_{1} + {a}_{2} {f}_{2}}$$

In this case, the variance of the carrier phase measurement errors ε_{φ}_{_{L1}}, ε_{φ}_{_{L2}} is represented as σ_{φ}_{_{L1}}², σ_{φ}_{_{L2}}², and the variance of the combined measurement error for the narrowlane combination is:

$${σ}_{{φ}_{N L}}^{2} = {( \frac{{a}_{1} {f}_{1}}{{a}_{1} {f}_{1} + {a}_{2} {f}_{2}} )}^{2} {σ}_{{φ}_{L 1}}^{2} + {( \frac{{a}_{2} {f}_{2}}{{a}_{1} {f}_{1} + {a}_{2} {f}_{2}} )}^{2} {σ}_{{φ}_{L 2}}^{2}$$

For example, in cases where σ_{φ}_{_{L1}}²=σ_{φ}_{_{L2}}², then σ_{φ}_{_{NL}}²<σ_{φ}_{_{L1}}²=σ_{φ}_{_{L2}}², and the variance of the combined measurement error is less than the variance of the measurement error for either of the carriers combined in the narrowlane combination. Alternatively, when the two variances are not equal, the combined measurement error may generally be smaller than at least one of the carriers that are combined in the narrowlane combination. As a result, when a positioning entity is performing an IAR algorithm based on narrowlane combination, the positioning entity may be configured to select a narrowlane combination that has a smaller combined wavelength to increase position estimation accuracy while also minimizing a combined phase error.

As indicated above, Fig. bis provided as an example. Other examples may differ from what is described with regard to FIG. 6.

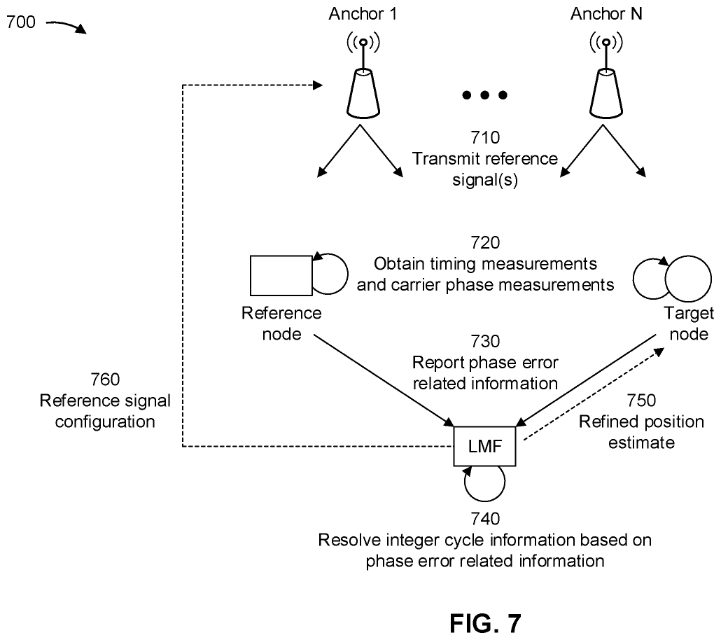

FIG. 7 is a diagram illustrating an example 700 associated with assistance data for position estimation using carrier phase combination in a cellular positioning system, in accordance with the present disclosure. As shown in FIG. 7, example 700 includes a target node, a reference node that may participate in estimating the position of the target node, a set of N anchor nodes that transmit positioning signals (e.g., a PRS or another suitable reference signal), and a location management function (LMF). In some aspects, the example 700 shown in FIG. 7 depicts UE-assisted position estimation in a cellular positioning system, where the target node may be a target UE whose position is to be estimated, the reference node may be a base station or a TRP having a known position, and the target node and the reference node act as assisting nodes to provide phase error related information to the LMF, which acts as a positioning node.

As shown in FIG. 7, and by reference number 710, each anchor node in the set of anchor nodes may transmit and/or receive one or more reference signals (e.g., a downlink, uplink, and/or sidelink PRS) that may be used for TDOA-based positioning in a cellular positioning system. For example, as described elsewhere herein, the anchor nodes may generally have fixed or otherwise known positions, whereby the reference node and the target node may measure time differences in the reference signals transmitted by the anchor nodes in order to calculate the location of the target node. For example, in TDOA-based positioning, the reference node and the target node may measure a time of arrival (TOA) for each reference signal received from an anchor node. The reference node and the target node may then subtract TOAs from one or more neighboring anchor nodes from a TOA of a reference anchor node (e.g., a serving base station) to obtain RSTD measurements. The RSTD measurements may determine multiple hyperbolas that intersect in a geometric area that represents a coarse estimated position of the target node. Accordingly, in some aspects, the cellular positioning system may further support carrier phase measurements based on a carrier phase combination (e.g., a combination of two or more component carriers) in a similar manner as described above with reference to FIGS. 3-6. For example, in some aspects, the anchor nodes included in the set of anchor nodes may transmit the reference signals on a combination of carriers to enable resolution of an integer number of cycles for carrier waves corresponding to the reference signals (e.g., using an 1AR algorithm).

As further shown in FIG. 7, and by reference number 720, the reference node and the target node may obtain timing measurements and carrier phase measurements associated with the reference signals transmitted by the anchor nodes. For example, in some aspects, the timing measurements may include RSTD measurements, and the carrier phase measurements may include a phase measurement, θ(t), at the receiver. Furthermore, in some aspects, the reference node and/or the target node may perform a double differencing operation to remove or mitigate transmitter and receiver errors in the timing measurements and the carrier phase measurements in a similar manner as described above with reference to FIGS. 4-5. Accordingly, in some aspects, the reference node and/or the target node may determine phase error related information associated with the reference signals based on the double differencing operation performed to remove or mitigate transmitter and receiver errors.

As further shown by reference number 730, the reference node and the target node may report the phase error related information to the LMF. For example, in cases where the reference node is a base station or a TRP, the reference node may report the phase error related information to the LMF using the NR Positioning Protocol A (NRPPa) (e.g., as defined in 3GPP TS 38.455). Furthermore, in cases where the target node is a UE, the target node may report the phase error related information to the LMF using the LTE Positioning Protocol (LPP) (e.g., as defined in 3GPP TS 36.355).

In some aspects, the phase error related information that the reference node and target node report to the LMF may include a single uncertainty value, a single uncertainty range, and/or a single uncertainty distribution for the timing and/or carrier phase measurements obtained by the reference node and the target node. Additionally, or alternatively, the phase error related information reported to the LMF may include a single estimation error value, a single estimation error range, and/or a single estimation error distribution for the timing and/or carrier phase measurements obtained by the reference node and the target node. Additionally, or alternatively, the phase error related information may include multiple element-wise uncertainty and/or estimation error values, ranges, and/or distributions. For example, in some aspects, the phase error related information may include uncertainty and/or estimation error values, ranges, and/or distributions caused by phase noise (e.g., based on a voltage-controlled oscillator (VCO) clock accuracy), a phase center variation (e.g., due to imperfect phase contour information and/or imperfect compensation), errors caused by one or more signal measurements (e.g., a signal-to-noise ratio (SNR) measurement, a signal-to-interference-plus-noise ratio (SINR) measurement, an RSRP measurement, and/or an RSRQ measurement), and/or any other suitable errors. In some aspects, the phase error related information may be defined with respect to a positioning frequency layer, a component carrier, a downlink bandwidth part, an uplink bandwidth part, a sidelink bandwidth part, a frequency sub-band, and/or other carrier-related parameters.

As further shown in FIG. 7, and by reference number 740, the LMF may resolve integer cycle information associated with the carrier phase measurements based on the phase error related information reported by the reference node and/or the target node. For example, in some aspects, the phase error related information may be reported to the LMF in each measurement report that includes timing measurements and carrier phase measurements obtained by the reference node and/or the target node. In this case, the LMF may use the timing measurements to determine an initial coarse estimate for the target node (e.g., after performing a double difference operation to eliminate or mitigate transmitter and receiver errors), and may use an IAR algorithm to resolve the integer cycle information associated with the carrier phase measurements. In some aspects, the IAR algorithm may be performed using a carrier phase combination (e.g., a combination of carriers used to transmit the reference signals) to minimize a combined error in the combined carrier phase measurements. Accordingly, based on the variance of the measurement errors for the combined carriers, σ_{φ}_{_{L1}}² and σ_{φ}_{_{L2}}², the LMF may select a carrier phase combination associated with carrier phase combination coefficients, a₁ and a₂, that minimizes the combined measurement error. In some aspects, based on the resolved integer cycle information, the LMF may be able to refine the coarse position estimate for the target node (e.g., by multiplying the carrier wavelength(s) by the integer number of cycles and the fractional phase measured at the receiver to determine distances or ranges between the target node and one or more anchors). As shown by reference number 750, the LMF may then transmit information that indicates the refined position estimate of the target node to the target node.

Additionally, or alternatively, the phase error related information may be provided to the LMF as assistance data. In this case, where the LMF is acting as the positioning node in UE-assisted positioning, the LMF may determine a PRS configuration based on the phase error related information reported by the reference node and/or the target node. For example, based on the phase error related information, the LMF may determine a carrier combination that may result in carrier phase measurements with a minimized phase error, and may determine a PRS configuration that uses the carrier combination that minimizes the measurement phase error. For example, based on the variance of the measurement errors for the combined carriers, σ_{φ}_{_{L1}}² and σ_{φ}_{_{L2}}², the LMF may select a carrier phase combination, f₁ and f₂, associated with carrier phase combination coefficients, a₁ and a₂, that minimizes the combined measurement error. In this way, as shown by reference number 760, the LMF may configure the anchor nodes to transmit the reference signals using the PRS configuration that minimizes the measurement phase error such that the reference node and the target node may obtain the carrier phase measurements on the combination of carriers that minimizes the measurement phase error. Accordingly, because the reference node and the target node obtain the carrier phase measurements on the combination of carriers associated with the PRS configuration, the LMF may determine the PRS configuration (e.g., the carrier combination) based on carriers that are preferred by the reference node and/or carriers that are preferred by the target node.

As indicated above, FIG. 7 is provided as an example. Other examples may differ from what is described with regard to FIG. 7.

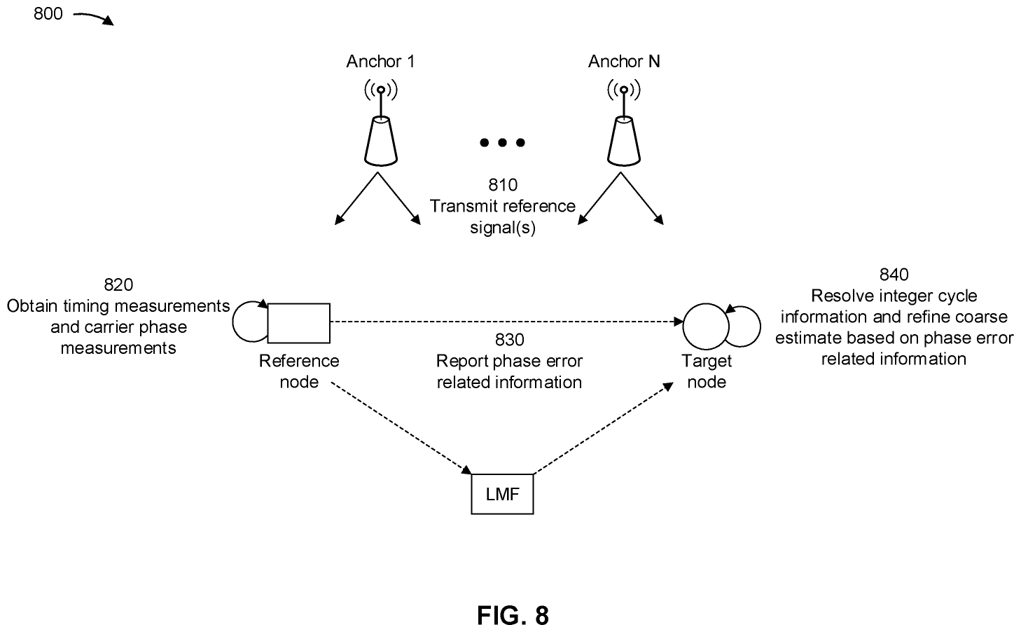

FIG. 8 is a diagram illustrating an example 800 associated with assistance data for position estimation using carrier phase combination in a cellular positioning system, in accordance with the present disclosure. As shown in FIG. 8, example 800 includes a target node, a reference node that may participate in estimating the position of the target node, and a set of N anchor nodes that transmit positioning signals (e.g., a PRS or another suitable reference signal). Furthermore, in some aspects, example 800 may optionally include an LMF (or another core network device) that may relay information from the reference node to the target node. In some aspects, the example 800 shown in FIG. 8 depicts UE-based position estimation in a cellular positioning system, where the target node may be a target UE that estimates its own position, and the reference node may be a base station or a TRP having a known position or a reference UE communicating with the target node on a sidelink. In this case, the reference node may act as an assisting node to provide phase error related information to the target node, which acts as a positioning node.

As shown in FIG. 8, and by reference number 810, each anchor node in the set of anchor nodes may transmit one or more reference signals (e.g., a downlink, uplink, and/or sidelink PRS) that may be used for TDOA-based positioning in a cellular positioning system. For example, as described elsewhere herein, the anchor nodes may generally have fixed or otherwise known positions, whereby the reference node and the target node may measure time differences in the reference signals transmitted by the anchor nodes in order to calculate the location of the target node. For example, in TDOA-based positioning, the reference node and the target node may measure a TOA for each reference signal received from an anchor node. The reference node and the target node may then subtract TOAs from one or more neighboring anchor nodes from a TOA of a reference anchor node (e.g., a serving base station) to obtain RSTD measurements. The RSTD measurements may determine multiple hyperbolas that intersect in a geometric area that represents a coarse estimated position of the target node. Accordingly, in some aspects, the cellular positioning system may further support carrier phase measurements based on a carrier phase combination (e.g., a combination of two or more component carriers) in a similar manner as described above with reference to FIGS. 3-6. For example, in some aspects, the anchor nodes included in the set of anchor nodes may transmit the reference signals on a combination of carriers to enable resolution of an integer number of cycles for carrier waves corresponding to the reference signals (e.g., using an IAR algorithm).

As further shown in FIG. 8, and by reference number 820, the reference node and the target node may obtain timing measurements and carrier phase measurements associated with the reference signals transmitted by the anchor nodes. For example, in some aspects, the timing measurements may include RSTD measurements, and the carrier phase measurements may include a phase measurement, θ(t), at the receiver. Furthermore, in some aspects, the reference node and/or the target node may perform a double differencing operation to remove or mitigate transmitter and receiver errors in the timing measurements and the carrier phase measurements in a similar manner as described above with reference to FIGS. 4-5. Accordingly, in some aspects, the reference node may determine phase error related information associated with the reference signals based on the double differencing operation performed to remove or mitigate transmitter and receiver errors.

As further shown by reference number 830, the reference node may report the phase error related information to the target node. For example, in cases where the reference node is a base station or a TRP, the reference node may transmit the phase error related information to the target node directly (e.g., in downlink control information (DCI) and/or a medium access control (MAC) control element (MAC-CE)). Alternatively, the base station or TRP acting as the reference node may transmit the phase error related information to the LMF using the NRPPa, and the LMF may relay the phase error related information to the target node via the LPP. Alternatively, in cases where the reference node is a reference UE (e.g., a fixed or stationary UE having a known position that can enable carrier phase measurement), the reference node may transmit the phase error related information to the target node directly via a sidelink channel (e.g., a PC5 interface) or indirectly via relaying through the LMF and/or another core network device.

In some aspects, the phase error related information that the reference node reports to the target node may include a single uncertainty value, a single uncertainty range, and/or a single uncertainty distribution for the timing and/or carrier phase measurements obtained by the reference node. Additionally, or alternatively, the phase error related information reported to the target node may include a single estimation error value, a single estimation error range, and/or a single estimation error distribution for the timing and/or carrier phase measurements obtained by the reference node. Additionally, or alternatively, the phase error related information may include multiple element-wise uncertainty and/or estimation error values, ranges, and/or distributions. For example, in some aspects, the phase error related information may include uncertainty and/or estimation error values, ranges, and/or distributions caused by phase noise (e.g., based on a VCO clock accuracy), a phase center variation (e.g., due to imperfect phase contour information and/or imperfect compensation), errors caused by one or more signal measurements (e.g., an SNR measurement, an SINR measurement, an RSRP measurement, and/or an RSRQ measurement), and/or any other suitable errors. In some aspects, the phase error related information may be defined with respect to a positioning frequency layer, a component carrier, a downlink bandwidth part, an uplink bandwidth part, a sidelink bandwidth part, a frequency sub-band, and/or other carrier-related parameters.

As further shown in FIG. 8, and by reference number 840, the target node may resolve integer cycle information associated with the carrier phase measurements based on the phase error related information reported by the reference node. For example, in some aspects, the phase error related information may be reported to the target node in a measurement report that includes timing measurements and carrier phase measurements obtained by the reference node. In this case, the target node may use the timing measurements to determine an initial coarse estimate (e.g., after performing a double difference operation to eliminate or mitigate transmitter and receiver errors), and may use an IAR algorithm to resolve the integer cycle information associated with the carrier phase measurements. In some aspects, the IAR algorithm may be performed using a carrier phase combination (e.g., a combination of carriers used to transmit the reference signals) to minimize a combined error in the combined carrier phase measurements. Accordingly, based on the variance of the measurement errors for the combined carriers, σ_{φ}_{_{L1}}² and σ_{φ}_{_{L2}}², the target node may select a carrier phase combination associated with carrier phase combination coefficients, a₁ and a₂, that minimizes the combined measurement error. In some aspects, based on the resolved integer cycle information, the target node may be able to refine the coarse position estimate (e.g., by multiplying the carrier wavelength(s) by the integer number of cycles and the fractional phase measured at the receiver to determine distances or ranges between the target node and one or more anchors).

As indicated above, FIG. 8 is provided as an example. Other examples may differ from what is described with regard to FIG. 8.

FIG. 9 is a diagram illustrating an example process 900 performed, for example, by a positioning node, in accordance with the present disclosure. Example process 900 is an example where the positioning node (e.g., a target UE in UE-based positioning or an LMF in UE-assisted positioning)) performs operations associated with assistance data for position estimation using carrier phase combination in a cellular positioning system.

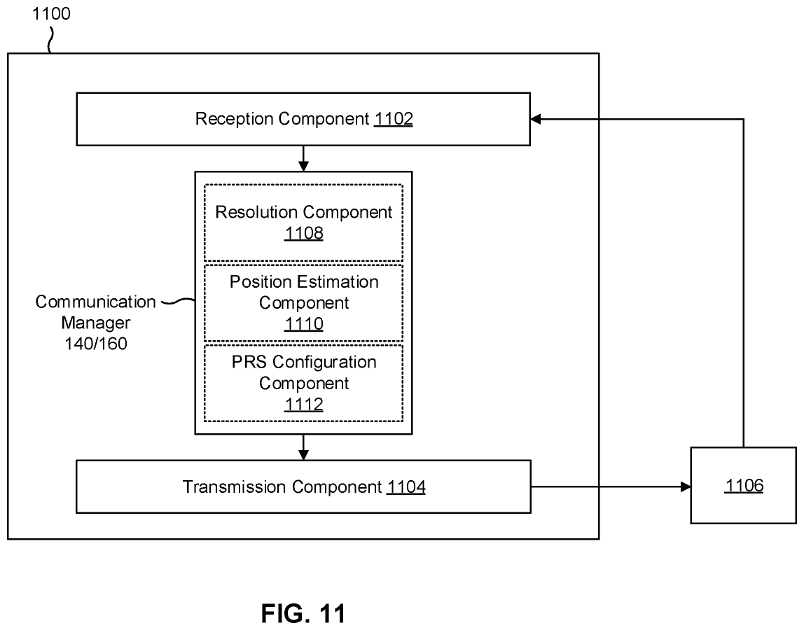

As shown in FIG. 9, in some aspects, process 900 may include receiving phase error related information associated with one or more carrier phase measurements obtained by one or more assisting nodes (block 910). For example, the positioning node (e.g., using communication manager 140/160 and/or reception component 1102, depicted in FIG. 11) may receive phase error related information associated with one or more carrier phase measurements obtained by one or more assisting nodes, as described above.

Process 900 may include additional aspects, such as any single aspect or any combination of aspects described below and/or in connection with one or more other processes described elsewhere herein.

In a first aspect, process 900 may include resolving integer cycle information associated with the one or more carrier phase measurements based at least in part on the phase error related information, and estimating a location associated with a target UE based at least in part on the integer cycle information associated with the one or more carrier phase measurements.

In a second aspect, alone or in combination with the first aspect, the phase error related information is associated with two or more carriers.

In a third aspect, alone or in combination with one or more of the first and second aspects, the phase error related information includes a value, a range, or a distribution associated with an uncertainty or estimation error of the one or more carrier phase measurements.

In a fourth aspect, alone or in combination with one or more of the first through third aspects, the phase error related information includes one or more uncertainties or one or more estimation errors that are caused by one or more of a phase noise, a phase center variation, or a signal measurement error.

In a fifth aspect, alone or in combination with one or more of the first through fourth aspects, the phase error related information is associated with one or more of a positioning frequency layer, a component carrier, a bandwidth part, or a frequency sub-band.

In a sixth aspect, alone or in combination with one or more of the first through fifth aspects, the phase error related information is received from the one or more assisting nodes in one or more measurement reports that include the one or more carrier phase measurements for the two or more carriers.

In a seventh aspect, alone or in combination with one or more of the first through sixth aspects, the one or more assisting nodes include the target UE and a reference node, and process 900 includes receiving, from the target UE and the reference node, the one or more carrier phase measurements in the one or more measurement reports, and refining a coarse estimate of the location associated with the target UE based at least in part on a carrier phase combination using the received carrier phase measurements and the integer cycle information associated with the one or more carrier phase measurements.

In an eighth aspect, alone or in combination with one or more of the first through seventh aspects, the positioning node is an LMF and the one or more assisting nodes include one or more of the target UE or a TRP.

In a ninth aspect, alone or in combination with one or more of the first through eighth aspects, process 900 includes configuring at least a carrier for a PRS based at least in part on the phase error related information associated with the one or more carrier phase measurements.

In a tenth aspect, alone or in combination with one or more of the first through ninth aspects, the positioning node is the target UE and the one or more assisting nodes include one or more of a TRP or a reference UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by an assisting node, in accordance with the present disclosure. Example process 1000 is an example where the assisting node (e.g., a base station, TRP, or reference UE in UE-based positioning or a base station, TRP, reference UE, and/or target UE in UE-assisted positioning) performs operations associated with assistance data for position estimation using carrier phase combination in a cellular positioning system.

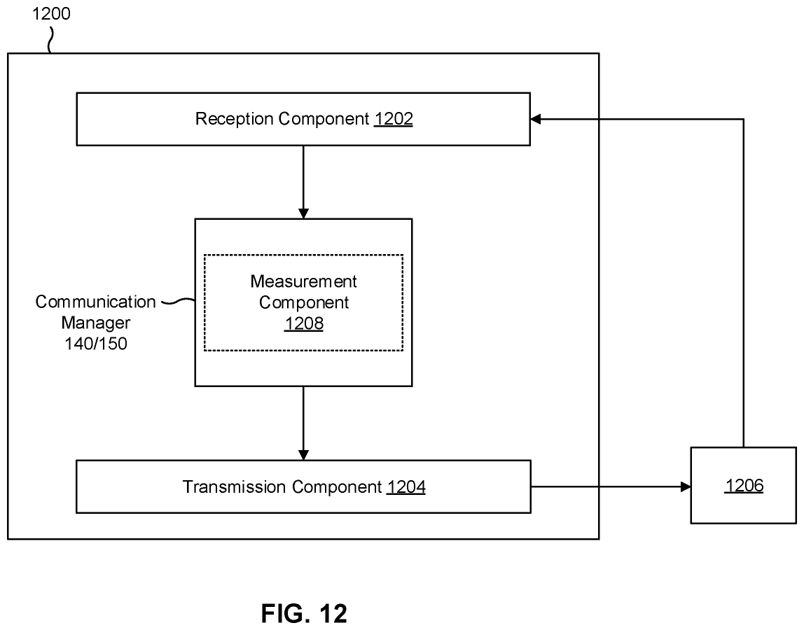

As shown in FIG. 10, in some aspects, process 1000 may include obtaining one or more carrier phase measurements (block 1010). For example, the assisting node (e.g., using communication manager 140/150 and/or measurement component 1208, depicted in FIG. 12) may obtain one or more carrier phase measurements, as described above.

As further shown in FIG. 10, in some aspects, process 1000 may include transmitting, to a positioning node, phase error related information associated with the one or more carrier phase measurements (block 1020). For example, the assisting node (e.g., using communication manager 140/150 and/or transmission component 1204, depicted in FIG. 12) may transmit, to a positioning node, phase error related information associated with the one or more carrier phase measurements, as described above.

Process 1000 may include additional aspects, such as any single aspect or any combination of aspects described below and/or in connection with one or more other processes described elsewhere herein.

In a first aspect, the phase error related information is associated with two or more carriers.

In a second aspect, alone or in combination with the first aspect, the phase error related information includes a value, a range, or a distribution associated with an uncertainty or estimation error of the one or more carrier phase measurements.

In a third aspect, alone or in combination with one or more of the first and second aspects, the phase error related information includes one or more uncertainties or one or more estimation errors that are caused by one or more of a phase noise, a phase center variation, or a signal measurement error.

In a fourth aspect, alone or in combination with one or more of the first through third aspects, the phase error related information is associated with one or more of a positioning frequency layer, a component carrier, a bandwidth part, or a frequency sub-band.

In a fifth aspect, alone or in combination with one or more of the first through fourth aspects, the phase error related information is transmitted to the positioning node in a measurement report that includes the one or more carrier phase measurements.

In a sixth aspect, alone or in combination with one or more of the first through fifth aspects, the positioning node is an LMF and the assisting node is a target UE or a TRP.

In a seventh aspect, alone or in combination with one or more of the first through sixth aspects, the positioning node is a target UE and the assisting node is a TRP or a reference UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a positioning node, or a positioning node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140 and/or the communication manager 160 described above with reference to FIGS. 1-2 (referred to herein as communication manager 140/160). As shown, the communication manager 140/160 may include one or more of a resolution component 1108, a position estimation component 1110, or a PRS configuration component 1112, among other examples.

In some aspects, the apparatus 1100 may be configured to perform one or more operations described herein in connection with FIGS. 3-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the positioning node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the positioning node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the positioning node described in connection with FIG. 2. In some aspects, the transmission component 1104 may be co-located with the reception component 1102 in a transceiver.

The reception component 1102 may receive phase error related information associated with one or more carrier phase measurements obtained by one or more assisting nodes.

The resolution component 1108 may resolve integer cycle information associated with the one or more carrier phase measurements based at least in part on the phase error related information. The position estimation component 1110 may estimate a location associated with a target UE based at least in part on the integer cycle information associated with the one or more carrier phase measurements.

The reception component 1102 may receive, from the target UE and the reference node, the one or more carrier phase measurements in the one or more measurement reports. The position estimation component 1110 may refine a coarse estimate of the location associated with the target UE based at least in part on a carrier phase combination using the received carrier phase measurements and the integer cycle information associated with the one or more carrier phase measurements.

The PRS configuration component 1112 may configure at least a carrier for a PRS based at least in part on the phase error related information associated with the one or more carrier phase measurements.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a assisting node, or a assisting node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1100 may include the communication manager 140 and/or the communication manager 150 described above with reference to FIGS. 1-2 (referred to herein as communication manager 140/150). As shown, the communication manager 140/150 may include a measurement component 1208, among other examples.

In some aspects, the apparatus 1200 may be configured to perform one or more operations described herein in connection with FIGS. 3-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the assisting node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the assisting node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the assisting node described in connection with FIG. 2. In some aspects, the transmission component 1204 may be co-located with the reception component 1202 in a transceiver.

The measurement component 1208 may obtain one or more carrier phase measurements. The transmission component 1204 may transmit, to a positioning node, phase error related information associated with the one or more carrier phase measurements.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a positioning node in a cellular positioning system, comprising: receiving phase error related information associated with one or more carrier phase measurements obtained by one or more assisting nodes.

Aspect 2: The method of Aspect 1, further comprising: resolving integer cycle information associated with the one or more carrier phase measurements based at least in part on the phase error related information; and estimating a location associated with a target UE based at least in part on the integer cycle information associated with the one or more carrier phase measurements.

Aspect 3: The method of Aspect 2, wherein the phase error related information is associated with two or more carriers.

Aspect 4: The method of Aspect 3, wherein the phase error related information includes a value, a range, or a distribution associated with an uncertainty or estimation error of the one or more carrier phase measurements.

Aspect 5: The method of any of Aspects 3-4, wherein the phase error related information includes one or more uncertainties or one or more estimation errors that are caused by one or more of a phase noise, a phase center variation, or a signal measurement error.

Aspect 6: The method of any of Aspects 3-5, wherein the phase error related information is associated with one or more of a positioning frequency layer, a component carrier, a bandwidth part, or a frequency sub-band.

Aspect 7: The method of any of Aspects 3-6, wherein the phase error related information is received from the one or more assisting nodes in one or more measurement reports that include the one or more carrier phase measurements for the two or more carriers.

Aspect 8: The method of Aspect 7, wherein the one or more assisting nodes include the target UE and a reference node, and wherein the method further comprises: receiving, from the target UE and the reference node, the one or more carrier phase measurements in the one or more measurement reports; and refining a coarse estimate of the location associated with the target UE based at least in part on a carrier phase combination using the received carrier phase measurements and the integer cycle information associated with the one or more carrier phase measurements.

Aspect 9: The method of any of Aspects 3-8, wherein the positioning node is an LMF and the one or more assisting nodes include one or more of the target UE or a TRP.

Aspect 10: The method of Aspect 9, further comprising: configuring at least a carrier for a PRS based at least in part on the phase error related information associated with the one or more carrier phase measurements.

Aspect 11: The method of any of Aspects 3-8, wherein the positioning node is a target UE and the one or more assisting nodes include one or more of a TRP or a reference UE.

Aspect 12: A method of wireless communication performed by an assisting node in a cellular positioning system, comprising: obtaining one or more carrier phase measurements; and transmitting, to a positioning node, phase error related information associated with the one or more carrier phase measurements.

Aspect 13: The method of Aspect 12, wherein the phase error related information is associated with two or more carriers.

Aspect 14: The method of Aspect 13, wherein the phase error related information includes a value, a range, or a distribution associated with an uncertainty or estimation error of the one or more carrier phase measurements.

Aspect 15: The method of any of Aspects 13-14, wherein the phase error related information includes one or more uncertainties or one or more estimation errors that are caused by one or more of a phase noise, a phase center variation, or a signal measurement error.

Aspect 16: The method of any of Aspects 13-15, wherein the phase error related information is associated with one or more of a positioning frequency layer, a component carrier, a bandwidth part, or a frequency sub-band.

Aspect 17: The method of any of Aspects 13-16, wherein the phase error related information is transmitted to the positioning node in a measurement report that includes the one or more carrier phase measurements.

Aspect 18: The method of any of Aspects 13-17, wherein the positioning node is an LMF and the assisting node is a target UE or a TRP.

Aspect 19: The method of any of Aspects 13-17, wherein the positioning node is a target UE and the assisting node is a TRP or a reference UE.

Aspect 20: An apparatus for wireless communication at a device, comprising a processor; memory coupled with the processor; and instructions stored in the memory and executable by the processor to cause the apparatus to perform the method of one or more of Aspects 1-11.

Aspect 21: A device for wireless communication, comprising a memory and one or more processors coupled to the memory, the one or more processors configured to perform the method of one or more of Aspects 1-11.

Aspect 22: An apparatus for wireless communication, comprising at least one means for performing the method of one or more of Aspects 1-11.

Aspect 23: A non-transitory computer-readable medium storing code for wireless communication, the code comprising instructions executable by a processor to perform the method of one or more of Aspects 1-11.

Aspect 24: A non-transitory computer-readable medium storing a set of instructions for wireless communication, the set of instructions comprising one or more instructions that, when executed by one or more processors of a device, cause the device to perform the method of one or more of Aspects 1-11.

Aspect 25: An apparatus for wireless communication at a device, comprising a processor; memory coupled with the processor; and instructions stored in the memory and executable by the processor to cause the apparatus to perform the method of one or more of Aspects 12-19.

Aspect 26: A device for wireless communication, comprising a memory and one or more processors coupled to the memory, the one or more processors configured to perform the method of one or more of Aspects 12-19.

Aspect 27: An apparatus for wireless communication, comprising at least one means for performing the method of one or more of Aspects 12-19.

Aspect 28: A non-transitory computer-readable medium storing code for wireless communication, the code comprising instructions executable by a processor to perform the method of one or more of Aspects 12-19.

Aspect 29: A non-transitory computer-readable medium storing a set of instructions for wireless communication, the set of instructions comprising one or more instructions that, when executed by one or more processors of a device, cause the device to perform the method of one or more of Aspects 12-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a positioning node in a cellular positioning system, comprising:
receiving phase error related information associated with one or more carrier phase measurements obtained by one or more assisting nodes.

2. The method of claim 1, further comprising:
resolving integer cycle information associated with the one or more carrier phase measurements based at least in part on the phase error related information; and
estimating a location associated with a target user equipment (UE) based at least in part on the integer cycle information associated with the one or more carrier phase measurements.

3. The method of claim 2, wherein the phase error related information is associated with two or more carriers.

4. The method of claim 3, wherein the phase error related information includes a value, a range, or a distribution associated with an uncertainty or estimation error of the one or more carrier phase measurements.

5. The method of claim 3, wherein the phase error related information includes one or more uncertainties or one or more estimation errors that are caused by one or more of a phase noise, a phase center variation, or a signal measurement error.

6. The method of claim 3, wherein the phase error related information is associated with one or more of a positioning frequency layer, a component carrier, a bandwidth part, or a frequency sub-band.

7. The method of claim 3, wherein the phase error related information is received from the one or more assisting nodes in one or more measurement reports that include the one or more carrier phase measurements for the two or more carriers.

8. The method of claim 7, wherein the one or more assisting nodes include the target UE and a reference node, and wherein the method further comprises:
receiving, from the target UE and the reference node, the one or more carrier phase measurements in the one or more measurement reports; and
refining a coarse estimate of the location associated with the target UE based at least in part on a carrier phase combination using the received carrier phase measurements and the integer cycle information associated with the one or more carrier phase measurements.

9. The method of claim 3, wherein the positioning node is a location management function and the one or more assisting nodes include one or more of the target UE or a transmit receive point.

10. The method of claim 9, further comprising:
configuring at least a carrier for a positioning reference signal based at least in part on the phase error related information associated with the one or more carrier phase measurements.

11. The method of claim 10, wherein the positioning node is the target UE and the one or more assisting nodes include one or more of a transmit receive point or a reference UE.

12. A method of wireless communication performed by an assisting node in a cellular positioning system, comprising:
obtaining one or more carrier phase measurements; and
transmitting, to a positioning node, phase error related information associated with the one or more carrier phase measurements.

13. The method of claim 12, wherein the phase error related information is associated with two or more carriers.

14. The method of claim 13, wherein the phase error related information includes a value, a range, or a distribution associated with an uncertainty or estimation error of the one or more carrier phase measurements.

15. The method of claim 13, wherein the phase error related information includes one or more uncertainties or one or more estimation errors that are caused by one or more of a phase noise, a phase center variation, or a signal measurement error.

16. The method of claim 13, wherein the phase error related information is associated with one or more of a positioning frequency layer, a component carrier, a bandwidth part, or a frequency sub-band.

17. The method of claim 13, wherein the phase error related information is transmitted to the positioning node in a measurement report that includes the one or more carrier phase measurements.

18. The method of claim 13, wherein the positioning node is a location management function and the assisting node is a target user equipment or a transmit receive point.

19. The method of claim 13, wherein the positioning node is a target user equipment (UE) and the assisting node is a transmit receive point or a reference UE.

20. A positioning node for wireless communication in a cellular positioning system, comprising:
a memory; and
one or more processors, coupled to the memory, configured to:
receive phase error related information associated with one or more carrier phase measurements obtained by one or more assisting nodes.

21. The positioning node of claim 20, wherein the one or more processors are further configured to:
resolve integer cycle information associated with the one or more carrier phase measurements based at least in part on the phase error related information; and
estimate a location associated with a target user equipment (UE) based at least in part on the integer cycle information associated with the one or more carrier phase measurements.

22. The positioning node of claim 21, wherein the phase error related information is associated with two or more carriers.

23. The positioning node of claim 22, wherein the phase error related information includes a value, a range, or a distribution associated with an uncertainty or estimation error of the one or more carrier phase measurements.

24. The positioning node of claim 22, wherein the phase error related information includes one or more uncertainties or one or more estimation errors that are caused by one or more of a phase noise, a phase center variation, or a signal measurement error.

25. The positioning node of claim 22, wherein the phase error related information is associated with one or more of a positioning frequency layer, a component carrier, a bandwidth part, or a frequency sub-band.

26. The positioning node of claim 22, wherein the phase error related information is received from the one or more assisting nodes in one or more measurement reports that include the one or more carrier phase measurements for the two or more carriers.

27. The positioning node of claim 26, wherein the one or more assisting nodes include the target UE and a reference node, and wherein the one or more processors are further configured to:
receive, from the target UE and the reference node, the one or more carrier phase measurements in the one or more measurement reports; and
refine a coarse estimate of the location associated with the target UE based at least in part on a carrier phase combination using the received carrier phase measurements and the integer cycle information associated with the one or more carrier phase measurements.

28. The positioning node of claim 22, wherein the positioning node is a location management function and the one or more assisting nodes include one or more of the target UE or a transmit receive point.

29. The positioning node of claim 28, wherein the one or more processors are further configured to:
configure at least a carrier for a positioning reference signal based at least in part on the phase error related information associated with the one or more carrier phase measurements.

30. An assisting node for wireless communication in a cellular positioning system, comprising:
a memory; and
one or more processors, coupled to the memory, configured to:
obtain one or more carrier phase measurements; and
transmit, to a positioning node, phase error related information associated with the one or more carrier phase measurements.
